(19) United States
(12) Patent Application Publication
(10) Pub. No.: US 2017/0320455 A1
(43) Pub. Date: Nov. 9, 2017

(54) VEHICLE BODY FRONT STRUCTURES

(71) Applicant: TOYODA IRON WORKS CO., LTD., Toyota-shi, Aichi (JP)

(72) Inventors: Takeshi NAKAYAMA, Toyota-shi (JP); Makoto NAKANISHI, Toyota-shi (JP); Michio SUZUMORI, Toyota-shi (JP); Yoshiaki HIGASHI, Toyota-shi (JP)

(73) Assignee: TOYODA IRON WORKS CO., LTD., Toyota-shi, Aichi (JP)

(21) Appl. No.: 15/535,325

(22) PCT Filed: Nov. 26, 2015
(86) PCT No.: PCT/JP2015/083289

§ 371 Date: Jun. 12, 2017

(30) Foreign Application Priority Data
Dec. 10, 2014 (JP) 2014-250423

(51) Int. Cl. B60R 19/34; B62D 21/15

(52) U.S. Cl. CPC B60R 19/34; B62D 21/152

(57) ABSTRACT

A vehicle body front structure including: a bumper beam; side member; and crash-box including a polygonal-tubular-body, the crash-box between the bumper beam end and side member with the tubular body parallel axis to the vehicle front-rear direction, wherein the crash-box absorbs impact energy as the tubular body is collapsed under compressive load applied from the bumper beam. The polygonal-tubular-body includes outer and inner sidewalls, wherein the outer and inner sidewalls are inclined laterally outwardly in the vehicle as they approach the bumper beam, wherein the outer sidewall inclination angle with respect to the vehicle front-rear direction is greater than the inner sidewall inclination angle. The bumper beam has at the end a first portion whose front side surface is perpendicular to the vehicle front-rear direction, extending from the terminal of the beam inwardly at least to the same lateral location as the laterally outer side of the side member.

### FIELD OF THE INVENTION

The present invention relates to vehicle body front structures, and more particularly to improvement for enhancing the impact absorbing performance under various collision circumstances including a small overlap offset collision.

### RELATED ART

Crash boxes are known that include a tubular body having a polygonal cross section disposed between the end of the bumper beam and the vehicle body, with the axis of the tubular body parallel to the front-rear direction of the vehicle. For example, Japanese Patent Application Publication No. 2010-76476 discloses one example of such crash boxes. In the crash box disclosed in Patent Document 1, the tubular body includes an outer sidewall, which is located laterally outward in the vehicle, and an inner sidewall, which is located laterally inward in the vehicle, and both the outer sidewall and the inner sidewall are inclined laterally outwardly in the vehicle as they go from the vehicle body to the bumper beam. The tubular body is collapsed into bellows to absorb impact energy when a compressive load is applied from the bumper beam to the tubular body in the axial direction. Furthermore, the outwardly inclined tubular body prevents itself from tilting laterally inwardly in the vehicle.

### SUMMARY OF INVENTION

The above prior art structure however may possibly not always efficiently transfer the collision forces rearwards through the vehicle in the event of a small overlap collision, i.e., a collision with a relatively small overlap between the collision barrier and the bumper beam, because the end of the bumper beam which extends outwardly beyond the crash box is subjected to bending as well as the crash box itself is tilted laterally inwardly in the vehicle from its base (i.e. the end adjacent to the vehicle body). This problem has been newly found by the present inventors during the continuous intensive research that aimed to improve the performance of the vehicle body front structures.

There is a need in the art for a vehicle body front structure with an improved impact absorbing performance under various collision circumstances including a small overlap offset collision.

An aspect of the present invention provides a vehicle body front structure including a bumper beam; a side member; and a crash box including a tubular body with a polygonal cross section, the crash box being disposed between an end of the bumper beam and the side member with an axis of the tubular body parallel to a front-rear direction of the vehicle, wherein the crash box absorbs impact energy as the tubular body is collapsed into bellows under a compressive load applied from the bumper beam to the tubular body in an axial direction; the tubular body including an outer sidewall located on the laterally outer side in the vehicle and an inner sidewall located on the laterally inner side in the vehicle, and wherein the outer sidewall and the inner sidewall are both inclined laterally outwardly in the vehicle as they go from the vehicle body toward the bumper beam, characterized in that: an inclination angle of the outer sidewall is greater than an inclination angle of the inner sidewall; and the bumper beam has a front side surface at each lateral end that is perpendicular to the front-rear direction of the vehicle and extends from a lateral terminal end to at least a position corresponding to a surface line of a laterally outer side of the side member.

In some embodiments, this configuration reduces the relative displacement of the colliding object laterally outwardly with respect to the vehicle even in the event of a small overlap offset collision to effectively transfer the collision load to the components of the vehicle rear structure. This provides a vehicle front structure with an improved impact absorbing performance under various collision circumstances including a small overlap offset collision.

In an embodiment, a portion of the bumper beam that is located laterally inward in the vehicle relative to the portion of the bumper beam whose front surface is perpendicular to the front-rear direction of the vehicle is bulged forwardly in the vehicle. This ensures design flexibility in the vehicle body front structure because the bulged portion can extend longer in the vehicle-width direction than in the case where the portion of the beam that is perpendicular to the front-rear direction of the vehicle covers the entire lateral dimension of the crash box.

### BRIEF DESCRIPTION OF THE DRAWINGS

FIG. 1 is a schematic plan view of a vehicle body front structure according to one embodiment of the present invention as seen downward from the top in the vertical direction of the vehicle.

FIG. 2 is a plan view of the crash box of FIG. 1 in isolation.

FIG. 3 is a sectional view taken along the line III-III of FIG. 2.

FIG. 4 is a sectional view taken along the line IV-IV of FIG. 3.

FIG. 5 shows deformation of elements of a prior art vehicle body front structure in the event of a collision for illustrating advantageous effects of the vehicle body front structure in embodiments over the prior art.

FIG. 6 shows deformation of elements of another prior art vehicle body front structure in the event of a collision for illustrating advantageous effects of the vehicle body front structure in embodiments over the prior art.

FIG. 7 shows deformation of elements of the vehicle body front structure of an embodiment in the event of a collision for illustrating advantageous effects of the vehicle body front structure in embodiments over the prior art.

### DETAILED DESCRIPTION OF THE INVENTION

In the present invention, the bumper beam has a first portion at each lateral end that has a front surface perpendicular to the front-rear direction of the vehicle and preferably partly covers the lateral dimension of the crash box. In other words, the first portion does not cover the entire lateral dimension of the crash box. Specifically, the laterally inner end point of the first portion is located laterally outward in the vehicle relative to the inner sidewall of the crash box.

The crash box may be included in bumper beam mounts attached in the vehicle front as well as in the vehicle rear. However, the crash box may be included in only one of the bumper beam mounts. Further, the crash box may be included in either one of the mounts that are on the right and left ends of the bumper beam. The crash box is disposed in the vehicle with the axis of the tubular body parallel to the front-rear direction of the vehicle. The crash box is inclined laterally outward in the vehicle as viewed in plan from above, but may be horizontally or vertically inclined in the vehicle front-rear direction as viewed from the side. The crash box may have a constant height (i.e. top to bottom dimension) as seen in a side view, or be tapered such that the height linearly increases or decreases as it approaches the bumper beam.

The crash box preferably includes, in addition to the tubular body, a pair of attachment plates for example, which is integrally secured to respective axial ends of the tubular body. The tubular body may preferably have an octagonal cross section, for example. However, a tubular body having other polygonal cross sections, such as quadrangular including rectangular and square cross sections for example, and hexagonal cross section may also be employed. As long as the tubular body has a generally polygonal cross section, the corners of the cross section (i.e. ridges) may be rounded such as in a circular arc. The polygonal tubular body may optionally have grooves that are recessed into the interior of the tubular body and extend in the axial direction of the tubular body. The number of the grooves may be appropriately determined. A plurality of grooves may be formed in any one sidewall. The groove may have various cross-sectional shapes such as V-section, U-section, semicircular, rectangular, and trapezoidal sections. The grooves may have the same or different depths. The depth of each groove may vary, linearly for example, along the axial direction of the tubular body.

Preferably, the tubular body may be formed of two halves. However, the tubular body may be made, for example, from a thin-walled metal tube, or in one piece from a resin material such as a fiber-reinforced plastic. The tubular body may be made by various methods, such as by bending a single metal plate into a predetermined polygonal form in cross section, and integrally joining overlapped edges of the metal plate.

The inclination angle of the outer sidewall is preferably within a range of, for example, approximately 10° to 30°, and more preferably within a range of approximately 15° to 25°. If the inclination angle of the outer sidewall is greater than 30°, the outer sidewall might easily bent toward the outer side of the vehicle from its base (i.e. the end adjacent to the vehicle body) in the event of a frontal or other collision. The inclination angle of the inner sidewall is preferably, for example, greater than 0° and equal to or smaller than 10°. The difference in inclination angle between the outer sidewall and the inner sidewall is preferably equal to or greater than 5°, and more preferably equal to or greater than 10°.

When the tubular body has an octagonal cross section, each of the outer inclined sidewalls may have, in spite of its inclination, a substantially constant width as it extends in the vehicle front-rear direction, so that the ridges between the outer inclined sidewalls and the upper and lower sidewalls are substantially parallel to the outer sidewall in a plan view as viewed in the top to bottom direction. Alternatively, each of the outer inclined sidewalls may have a linearly increasing width as it approaches the bumper beam, so that each of the upper sidewall and the lower sidewall has a substantially constant width.

Further embodiments of the present invention will be described below in detail with reference to the drawings. Features may not be drawn to scale in the figures referenced in the following description.

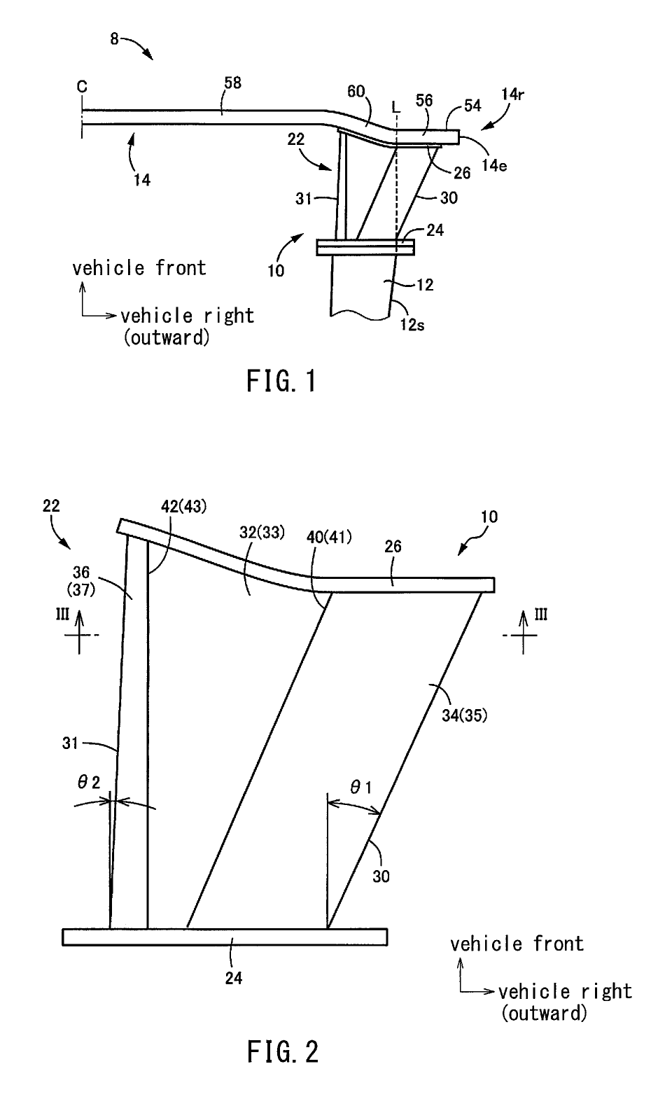

FIG. 1 is a schematic plan view of a vehicle body front structure 8 according to one embodiment of the present invention as seen downward from the top in the vertical direction of a vehicle. FIG. 1 is a plan view illustrating the right half of the vehicle 8; the left half is not shown because it may be symmetrical to the right half of the vehicle with respect to the center line of the vehicle. As shown in FIG. 1, the vehicle body front structure 8 includes a crash box 10, a side member 12 and a bumper beam 14. The crash box 10 is disposed between the side member 12 and the right end 14r of the bumper beam 14. The crash box 10 includes a hollow tubular body 22 of a polygonal cross section formed of a plurality of planar sidewalls, and a pair of attachment plates 24, 26 that is integrally secured by welding to respective axial ends of the tubular body 22. The attachment plate 24 is located at the axial end of the tubular body 22 adjacent to the side member 12. The attachment plate 26 is located at the axial end of the tubular body 22 adjacent to the bumper beam 14. The crash box 10 is disposed between the side member 12 and the bumper beam 14 with the axis of the tubular body 22 parallel to the front-rear direction of the vehicle, or, more precisely, is laterally outwardly inclined from the front-rear direction. The crash box 10 is integrally fixed to the side member 12 and the bumper beam 14 via the attachment plates 24, 26 with bolts (not shown) etc.

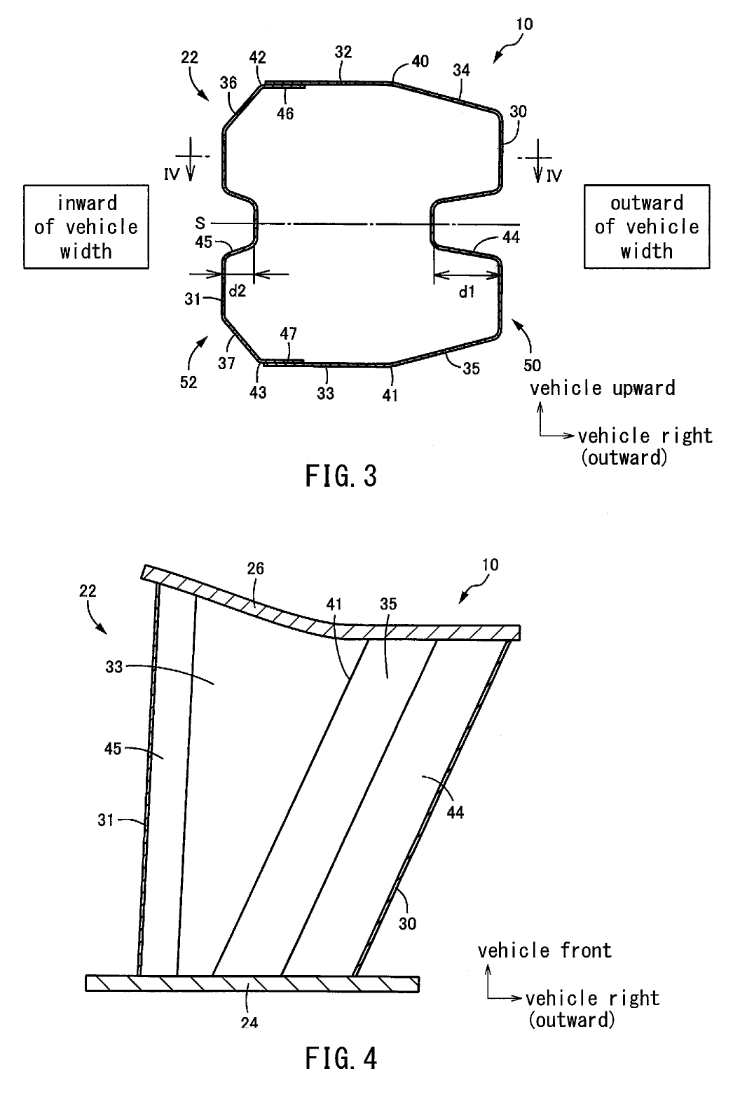

FIGS. 2 to 4 illustrate the structure of the crash box 10 provided on the vehicle body front structure 8, in which FIG. 2 is a plan view of FIG. 1. FIG. 3 is a sectional view taken along the line III-III, and FIG. 4 is a sectional view taken along the line IV-IV. The edges of the axial ends of the tubular body 22 are integrally secured to the attachment plates 24, 26 by arc welding or other welding method, making substantially close contact with the plates over the entire circumference of the edges. When the crash box 10 receives a compressive load in its axial direction due to an impact from the front of the vehicle, the tubular body 22 is collapsed into bellows and the impact energy is absorbed through the deformation of the tubular body 22, which reduces impact forces transferred to the side member 12 and other structural members of the vehicle. The collapse of the tubular body 22 into bellows is the result of successive bucklings (or angularly foldings) of the tubular body 22 at its multiple portions along the axial direction. Usually, the buckling starts from the side of the tubular body adjacent to the bumper beam 14, i.e., the input side, and proceeds over time toward the side adjacent to the vehicle body or side member 12. The bumper beam 14 serves as a reinforcement and attachment member for the bumper, and a bumper fascia made of, for example, synthetic resin may be integrally fitted thereto.

As shown in FIG. 3, the tubular body 22 may have a polygonal cross section. For example, the cross section may be basically octagonal, i.e. rectangular with four corners chamfered. The tubular body 22 includes: an outer sidewall 30 and an inner sidewall 31 that extend substantially vertical and are positioned on the laterally outer and inner sides, respectively, in the vehicle; an upper sidewall 32 and a lower sidewall 33 that extend substantially horizontal and are positioned on the top and bottom sides, respectively, in the vehicle; outer inclined sidewalls 34, 35 that extend between the upper and lower sidewalls 32, 33, respectively, and the outer sidewall 30; and inner inclined sidewalls 36, 37 that extend between the upper and lower sidewalls 32, 33, respectively, and the inner sidewall 31. As shown in FIG. 2, the outer sidewall 30 and the inner sidewall 31 are both inclined laterally outwardly in the vehicle as they approach the attachment plate 26. The inclination angle θ1 of the outer sidewall 30 is greater than the inclination angle θ2 of the inner sidewall 31. For example, the inclination angle θ1 of the outer sidewall 30 is about 24° and the inclination angle θ2 of the inner sidewall 31 is about 2.5°, so that the difference between θ1 and θ2 is approximately 21.5°. The angles of inclination θ1, θ2 refer to the inclination angle in a plan view with respect to an axis extending in the front-rear direction of the vehicle.

As shown in FIG. 2, the outer inclined sidewalls 34, 35 may have a substantially constant width such that the ridges 40, 41 between the upper sidewall 32 and the lower sidewall 33 extend substantially parallel to the outer sidewall 30 as viewed in plan in the top to bottom direction of the vehicle. The width of each of the upper sidewall 32 and the lower sidewall 33 increases gradually toward the bumper beam 14 in accordance with the inclination of the outer sidewall 30. The ridges 42, 43 between the inner inclined sidewalls 36, 37 and the upper and lower sidewalls 32, 33 extend substantially parallel to the axis, which extends in the front-rear direction of the vehicle, as viewed in plan in the top to bottom direction of the vehicle. More specifically, the width of each of the inner inclined sidewalls 36, 37 decreases as it approaches the bumper beam 14. The outer sidewall 30 and the inner sidewall 31, shown on the right and left sides, have respective grooves 44, 45, which are recessed inwardly into the tubular body 22, in the middle of its height, i.e., at the portions that lies on the horizontal axis S that passes through the center of the top to bottom dimension as shown in FIG. 3. Each of the grooves 44, 45 has a trapezoidal cross section with the width decreasing toward its distal end, i.e., toward its groove bottom, and the grooves have constant depths d1, d2 over the entire axial length of the tubular body 22. The depth d1 of the groove 44 is greater than the depth d2 of the groove 45. For example, the depth d1 of the groove 44 is about 30 mm, and the depth d2 of the groove 45 is about 14 mm.

The tubular body 22 may be composed of two halves split near the ridges 42, 43, the outer half 50 and inner half 52, joined together, each of which are formed by press working. Specifically, the outer half 50, located laterally outward in the vehicle, is a single-piece member including the outer sidewall 30 with the groove 44, the two outer inclined sidewalls 34, 35 that obliquely extends respectively laterally inwardly from the upper and lower ends of the outer sidewall 30 in the vehicle, and the upper sidewall 32 and the lower sidewall 33 that horizontally extend respectively from ends of the pair of outer inclined sidewalls 34, 35. The inner half 52, located laterally inward in the vehicle, is a single-piece member including the inner sidewall 31 with the groove 45, and the two inner inclined sidewalls 36, 37 that obliquely extends respectively laterally outward from the upper and lower ends of the inner sidewall 31 in the vehicle. The inner inclined sidewalls 36, 37 in the inner half 52 have joint portions 46, 47 at the distal ends that are respectively placed on the inner surfaces of the upper sidewall 32 and the lower sidewall 33 of the outer half 50. The inner inclined sidewall 36 of the inner half 52 and the upper sidewall 32 of the outer half 50 are integrally joined at the joint portion 46, and the inner inclined sidewall 37 of the outer half 50 and the lower sidewall 33 of the outer half 50 are integrally joined at the joint portion 47 by spot welding, arc welding, or other welding method.

As shown in FIG. 1, the bumper beam 14 of the vehicle body front structure 8 in an embodiment has a front side surface 54 at each lateral end that is perpendicular to the front-rear direction of the vehicle and extends from the lateral terminal end 14e to at least a position corresponding to the surface line 12s of the laterally outer side of the side member 12. In an embodiment, the position corresponding to the surface line 12s of the laterally outer side of the side member 12 corresponds to a position at the laterally outer side of the side member 12 at the end (i.e. terminal) adjacent to the crash box 10 (surface line 12s). This position is indicated in FIG. 1 with a dotted line L. More specifically, the bumper beam 14 of the vehicle body front structure 8 has a planar portion 56 that extends perpendicular to the front-rear direction of the vehicle and extends from the lateral terminal end 14e to at least a position corresponding to the surface line 12s of the laterally outer side of the side member 12.

In the vehicle body front structure 8, a portion of the bumper beam 14 that is located laterally inward in the vehicle relative to the left and right planar portions 56 is preferably bulged forwardly in the vehicle. Preferably, the bumper beam 14 has, between the left and right planar portions 56, another planar portion 58 shifted forward in the vehicle from the first planar portions 56. This planar portion 58 is perpendicular to the front-rear direction of the vehicle. The planar portions 56 and the planar portion 58 are smoothly connected through transitional portions 60. In this way, the bumper beam 14 is generally in a bow-like shape (the profile of a shooting bow) as viewed in plan in the top to bottom direction of the vehicle.

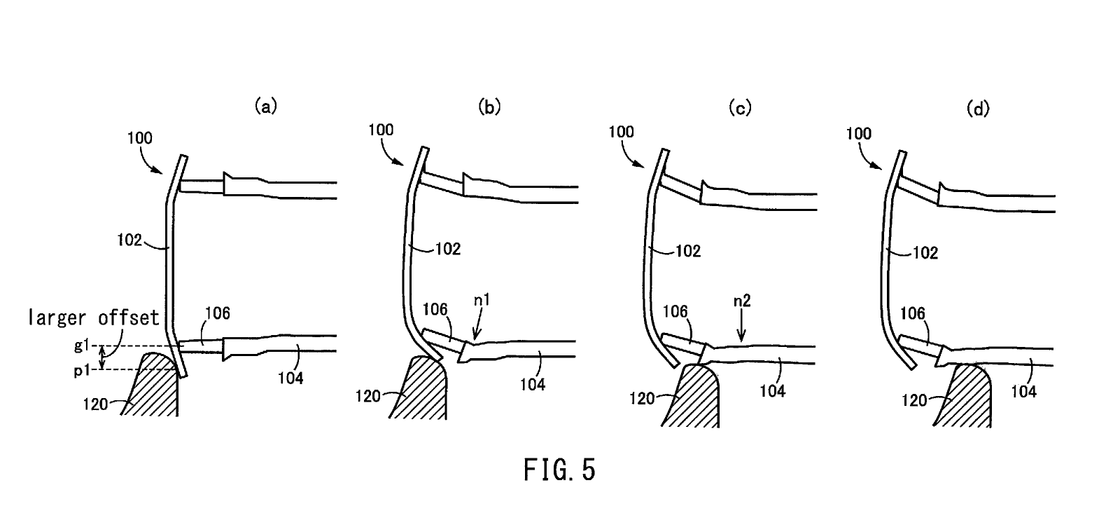

FIG. 5 to FIG. 7 illustrate advantageous effects of the vehicle body front structure 8 in embodiments over the prior art by showing results of a computer simulation of the event of a small overlap offset collision in which a vehicle including the vehicle body front structure 8 collides on the left end of the bumper beam while travelling at 641 cm/h. Each of FIGS. 5 to 7 shows the front structure (a) at the moment of impact, (b) when the vehicle has traveled further forward after the impact until the vehicle and a collision bather 120 have traveled 160 mm relative to each other in the front-rear direction of the vehicle, (c) when the vehicle and the collision bather 120 have moved 320 mm relative to each other in the front-rear direction, and (d) when the vehicle and the collision barrier 120 have moved 480 mm relative to each other in the front-rear direction of the vehicle.

FIG. 5 illustrates deformations of elements of a prior art structure in the event of a small overlap offset collision with the left side end of the bumper beam 102, where the prior art structure comprise a vehicle body front structure 100 including a crash box 106, which is disposed between a conventional bumper beam 102 with no planar portions at either lateral ends and the side member 104 so that the outer sidewall and the inner sidewall are substantially parallel to the vehicle front-rear direction (i.e., not inclined with respect to the vehicle front-rear direction). As shown in FIG. 5 (a), in the event of collision a bending moment occurs to push the side member 104 laterally inwardly in the vehicle because of the positional relation (i.e. offset relation) between the center g1 of the side member and the contact point p1 of the collision bather 120 with the bumper beam 102. If the bumper beam 102 has no planar portions 56 at the lateral ends so that the ends are gently curved (or rounded) toward the vehicle rear as shown in FIG. 5, the collision barrier 120 then slips on the surface of the bumper beam 102, promoting the tilting of the side member 104 (or the crash box 106). In the example shown in FIG. 5, the front end of the left side member 104 is bent so that the left crash box 106 is inclined inwardly as indicated by an arrow n1 in FIG. 5(b) after the vehicle has moved 160 mm relative to the collision barrier 120 in the front-rear direction of the vehicle. When the vehicle further moves relative to the collision bather 120 in the front-rear direction of the vehicle until the collision barrier 120 goes beyond the bumper beam 102, the barrier completely pushes the side member 104 laterally inwardly so that the bent part indicated by the arrow n1 is further deformed. In this way, the prior art vehicle body front structure 100 shown in FIG. 5 could not efficiently transfer the impact energy rearwards through the vehicle because the side member 104 and the crash box 106 are tilted inwardly.

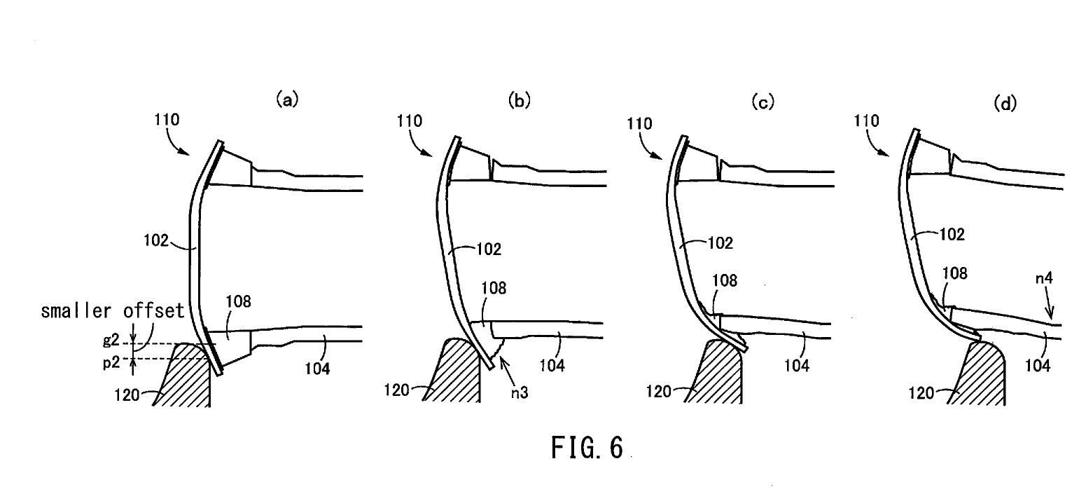

FIG. 6 illustrates deformations of elements of a prior art structure in the event of a small overlap offset collision with the left side end of the bumper beam 102, where the prior art structure comprise a vehicle body front structure 110 including a crash box 108, which is disposed between a conventional bumper beam 102 with no planar portion 56 at either lateral ends and the side member 104 such that the outer sidewall and the inner sidewall extend obliquely to the vehicle front-rear direction (i.e., not inclined with respect to the vehicle front-rear direction. The outer sidewall and inner sidewall are both inclined laterally outwardly in the vehicle as they go from the side member 104 toward the bumper beam 102, and the inclination angle of the outer sidewall is greater than the inclination angle of the inner sidewall. Accordingly, the crash box 108 has a similar structure as that of the crash box 10 in the vehicle body front structure 8 in the embodiment described above. In the vehicle body front structure 110 shown in FIG. 6, because the center g2 of the side member 104 (crash box 108) is located more laterally outward in the vehicle than in the vehicle body front structure 100 described above with reference to FIG. 5, the offset with respect to the contact point p2 with the collision barrier 120 is smaller, resulting in reduced bending moment that is due to collision on the collision barrier 120. However, since the bumper beam 102 has no planar portions at either lateral ends so that the ends are gently bent similarly to those of the vehicle body front structure 100, the collision barrier 120 slips on the surface of the bumper beam 102. In the example as shown in FIG. 6, the outer ridge of the crash box 108 cannot fulfill the function as an impact absorber anymore because the left crash box 108 is bent from its base as indicated by an arrow n3 in FIG. 6(b) as early as the vehicle have traveled 160 mm relative to the collision barrier 120 in the front-rear direction of the vehicle. Furthermore, the left crash box 108 has squeezed between the side member 104 and the bumper beam 102, and, when this deformation of the left crash box 108 reaches the limit, the side member 104 is deformed as indicated by an arrow n4 in FIG. 6(d) due to a pushing force acting laterally inwardly in the vehicle. More specifically, the prior art vehicle body front structure 110 as shown in FIG. 6 could not efficiently transfer the impact energy to the side member 104 because the crash box 108 is bent at its base on the laterally outer side.

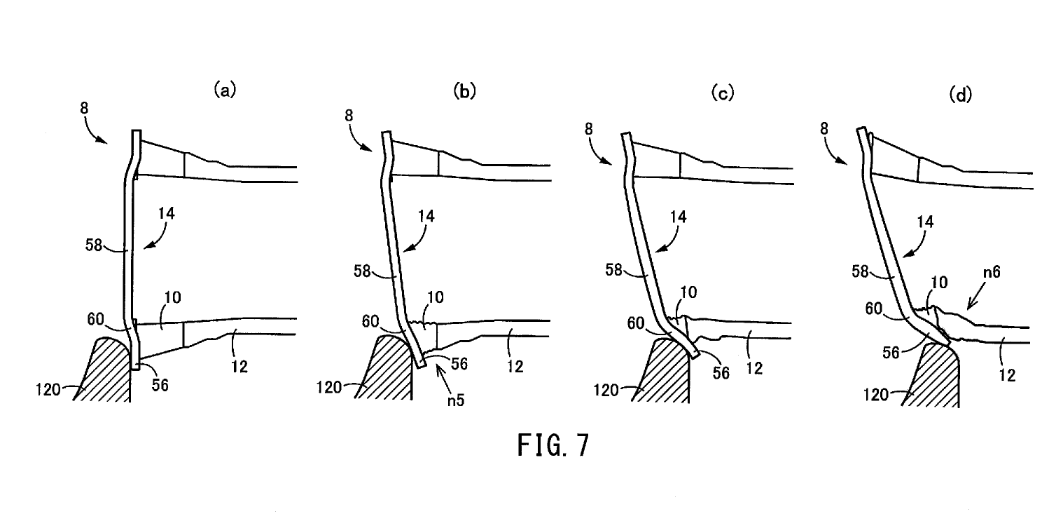

FIG. 7 illustrates deformations of elements of the vehicle body front structure 8 in the embodiment described above in the event of a small overlap collision on the left end of the bumper beam 14. The vehicle body front structure 8 in the embodiment shown in FIG. 7 may favorably prevent the impact barrier 120 from slipping on the surface of the bumper beam 102 because the bumper beam 14 has the planar portions 56 at both lateral ends, i.e., the bumper beam 14 is of a generally bow-like form in a plan view. In the example shown in FIG. 7, when the vehicle have traveled relative to the collision barrier 120 in the front-rear direction of the vehicle, the outer ridge of the left crash box 10 is successfully collapsed in an axial direction as indicated by an arrow n5 in FIG. 7(b) and thus fulfills the function as an impact absorber, when the vehicle have traveled 480 mm relative to the collision barrier 120 in the front-rear direction of the vehicle, the left crash box 10 is squeezed between the side member 12 and the bumper beam 14, and, when this deformation reaches the limit, the side member 12 is bent inwardly as indicated by an arrow n6 in FIG. 7(d). However, before this stage, sufficient load is applied to the crash box 10, therefore, the side member 12 can be bent at a relatively forward part. In this way, the vehicle body front structure 8 according to the embodiment described above can achieve efficient impact absorption due to axial collapse of the crash box 10.

In the embodiments described above, the inclination angle θ1 of the outer sidewall 30 is greater than the inclination angle θ2 of the inner sidewall 31, and front side surfaces 54 on both lateral ends of the bumper beam 14 are perpendicular to the front-rear direction of the vehicle from a lateral terminal end 14e to at least a position corresponding to the surface line 12s of the laterally outer side of the side member 12. This configuration reduces the relative displacement of the impact barrier 120 laterally outwardly with respect to the vehicle even in the event of a small overlap offset collision to effectively transfer the collision load to components of the vehicle rear structure. Specifically, this provides a vehicle front structure 8 with an improved impact absorbing performance under various collision circumstances including a small overlap offset collision.

A portion of the bumper beam 14 that is located laterally inward in the vehicle relative to the planar portions 56 whose front side surface 54 is perpendicular to the front-rear direction of the vehicle, is bulged further forward in the vehicle front. This configuration ensures design flexibility in the vehicle body front structure 8 because the bulged portion can be made longer in the vehicle-width direction than in the case where the planar portion 56 perpendicular to the front-rear direction of the vehicle is provided to cover the entire lateral dimension of the crash box 10.

When the planar portion 56 of the bumper beam 14 covers the entire lateral dimension of the crash box 10, a longer bulged portion would require the transitional portion 60 between the planar portions 56, 58 to have a larger curvature, which makes it difficult to form the bumper beam 14. However, such a disadvantage can be avoided by the embodiments described above.

While preferred embodiments of the present invention have been described above in detail with reference to the drawings, the present invention is not limited to those embodiments and may be implemented by making various changes without departing from the scope of the invention.

1. A vehicle body front structure comprising:
a bumper beam;
a side member; and
a crash box including a polygonal tubular body, the crash box being disposed between an end of the bumper beam and the side member with an axis of the tubular body parallel to a front-rear direction of the vehicle, wherein the crash box absorbs impact energy as the tubular body is collapsed under a compressive load applied from the bumper beam;
the polygonal tubular body including an outer sidewall and an inner sidewall, wherein the outer sidewall and the inner sidewall are both inclined laterally outwardly in the vehicle as they approach the bumper beam, wherein an inclination angle of the outer sidewall with respect to the front-rear direction of the vehicle is greater than an inclination angle of the inner sidewall; and
the bumper beam having at the end a first portion whose front side surface is perpendicular to the front-rear direction of the vehicle and which extends from the terminal of the beam inwardly at least to the same lateral location as the laterally outer side of the side member.

2. The vehicle body front structure according to claim 1, wherein the first portion of the bumper beam does not extend inwardly beyond the inner sidewall of the tubular body.

3. The vehicle body front structure according to claim 1, wherein the bumper beam has a second portion that is located laterally inward in the vehicle relative to first portion and is shifted forwardly in the vehicle.

4. The vehicle body front structure according to claim 3, wherein the bumper has a transitional portion smoothly connecting the first and second portions.

5. The vehicle body front structure according to claim 3, wherein the outer sidewall of the tubular body supports the first portion of the bumper beam while the inner sidewall of the tubular body supports the transitional portion of the bumper beam.
